(19) United States
(12) Patent Application Publication
(10) Pub. No.: US 2026/0326492 A1
(43) Pub. Date: Oct. 22, 2026

(54) SHOCK ABSORBER EXOSKELETON

(71) Applicant: Ford Global Technologies, LLC, Dearborn, MI (US)

(72) Inventors: David D. FRISKE, Wolverine Lake, MI (US); Michael Joseph NIKSA, Royal Oak, MI (US); Keith WESTON, Canton, MI (US)

(21) Appl. No.: 19/185,911

(22) Filed: Apr. 22, 2025

(51) Int. Cl. B60G 13/08; B60G 17/00; B60G 17/08; B62D 35/02; F16D 65/78

(52) U.S. Cl. CPC B60G 13/08; B60G 17/002; B60G 17/08; B62D 35/02; F16D 65/78; B60G 2202/24; B60G 2204/201; B60G 2204/202; B60G 2204/4305; B60G 2204/4308; B60G 2204/62; B60G 2206/012; B60G 2206/41; B60G 2206/70; B60G 2400/7162; B60G 2500/104; B60G 2600/182; B60G 2600/21; B60G 2600/72; B60G 2800/162; B60G 2800/916

(57) ABSTRACT

A shock absorber may include a housing which may be disposed between a wheel of the vehicle and a body of the vehicle, and an exoskeleton which may be operably coupled to an exterior surface of the housing. The exoskeleton may include an internal interface which may be operably coupleable to the exterior surface of the housing and an external interface which may be operably coupleable to other components of the vehicle via a mounting interface which may be integrally formed at the external interface. The internal interface may be substantially similar in size and shape to the exterior surface of the housing. The external interface may change one or more performance metrics of the shock absorber.

### TECHNICAL FIELD

Example embodiments generally relate to suspension components for a vehicle and, more particularly, relate to an exoskeleton for a shock absorber housing.

### BACKGROUND

Many modern vehicles may be produced in a variety of “trim” levels which may offer different features and occasionally different levels of performance as the trim level changes. In some cases, the vehicles may often share numerous components across all trim levels that may be offered for that particular model of vehicle to reduce the complexity of manufacturing that model of vehicle. In fact, some vehicles may even share components across different production models as well, which may reduce the complexity of manufacturing the models that share components. Despite the fact that many components, including suspension components, may be shared across trim levels and models, these components may occasionally need to exhibit different characteristics depending on the trim or model of vehicle on which they may be implemented. Thus, in some cases, it may be desirable to alter the performance characteristics of a component shared across different trims and models of vehicles to change vehicle performance without increasing the manufacturing complexity of the vehicle.

### BRIEF SUMMARY OF SOME EXAMPLES

Some example embodiments may provide for a shock absorber for a suspension assembly of a vehicle. The shock absorber may include a housing which may be disposed between a wheel of the vehicle and a body of the vehicle, and an exoskeleton which may be operably coupled to an exterior surface of the housing. The exoskeleton may include an internal interface which may be operably coupleable to the exterior surface of the housing and an external interface which may be operably coupleable to other components of the vehicle via a mounting interface which may be integrally formed at the external interface. The internal interface may be substantially similar in size and shape to the exterior surface of the housing. The external interface may change one or more performance metrics of the shock absorber.

Some example embodiments may provide for an exoskeleton for a shock absorber for a suspension assembly of a vehicle which may have a housing disposed between a wheel of the vehicle and a body of the vehicle. The exoskeleton may include an internal interface which may be operably coupleable to the exterior surface of the housing and an external interface which may be operably coupleable to other components of the vehicle via a mounting interface which may be integrally formed at the external interface. The internal interface may be substantially similar in size and shape to the exterior surface of the housing. The external interface may change one or more performance metrics of the shock absorber.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a block diagram of a suspension assembly of a vehicle according to an example embodiment;

FIG. 2 illustrates a perspective view of a shock absorber for a suspension assembly of a vehicle with the exoskeleton removed in accordance with an example embodiment;

FIG. 3 illustrates a top section view of the shock absorber from FIG. 2 in accordance with an example embodiment;

FIG. 4 illustrates a perspective view of the shock absorber having an exoskeleton in accordance with an example embodiment;

FIG. 5 illustrates a top section view of the shock absorber from FIG. 4 in accordance with an example embodiment;

FIG. 6 illustrates a perspective view of the shock absorber having an exoskeleton in accordance with an example embodiment;

FIG. 7 illustrates a perspective view of the shock absorber having an exoskeleton in accordance with an example embodiment;

FIG. 8 illustrates a perspective view of the shock absorber having an exoskeleton in accordance with an example embodiment;

FIG. 9 illustrates a close up perspective view of the exoskeleton from FIG. 8 in accordance with an example embodiment;

FIG. 10 illustrates a close up bottom perspective view of the exoskeleton from FIG. 8 in accordance with an example embodiment;

FIG. 11 illustrates a perspective view of the shock absorber having an exoskeleton in accordance with an example embodiment;

FIG. 12 illustrates a close up perspective view of the exoskeleton from FIG. 11 in accordance with an example embodiment;

FIG. 13 illustrates a perspective view of the shock absorber having an exoskeleton in accordance with an example embodiment; and

FIG. 14 illustrates a close up perspective view of the exoskeleton from FIG. 13 in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Additionally, as used herein, terminology such as “about,” “approximately” and “substantially,” when used to refer to variability of parameters, should be understood to be definite approximations that account for variations in measurements that cannot be, or as one of skill in the art would appreciate, normally are not, measured precisely. Thus, for example, a parameter that is “about,” “approximately” or “substantially” a given value or a given characteristic should be understood to be sufficiently close to the given value or given characteristic such that performance of the object or product to which the parameter applies, from the perspective of one with ordinary skill in the art, is the same as though the object or product had precisely the given value or characteristic.

Some non-limiting examples may include an exoskeleton for a shock absorber that may provide additional attachment locations to the exterior of the housing as well as performance metrics changes such as temperature control considerations, aerodynamic considerations, damping considerations and stiffness considerations. The shock absorber may be implemented across a variety of trims and models of vehicles, and the exoskeleton may operably couple to the exterior of the shock absorber housing to adapt the shock absorber for use in certain vehicles. In some cases, the exoskeleton may be compatible with various shock absorber housing constructions, such as monotube, twin tube, electronically controlled dampers, strut dampers, etc. In an example embodiment, the exoskeleton may be produced via additive manufacturing techniques and may be operably coupled to the exterior of the shock absorber housing via crimping, welding, adhesive, or the like. By adding the exoskeleton to the shock absorber housing, the shock absorber may exhibit at least one changed performance characteristic that may enable the shock absorber housing to perform differently with the exoskeleton than without it. Thus, the shock absorber may be shared across a variety of vehicle trims and models and may be adapted for use on a specific trim or model via the exoskeleton. Some non-limiting examples may therefore reduce the manufacturing complexity of producing a variety of trims and models of vehicles by increasing the ability to share components across vehicle trims and models.

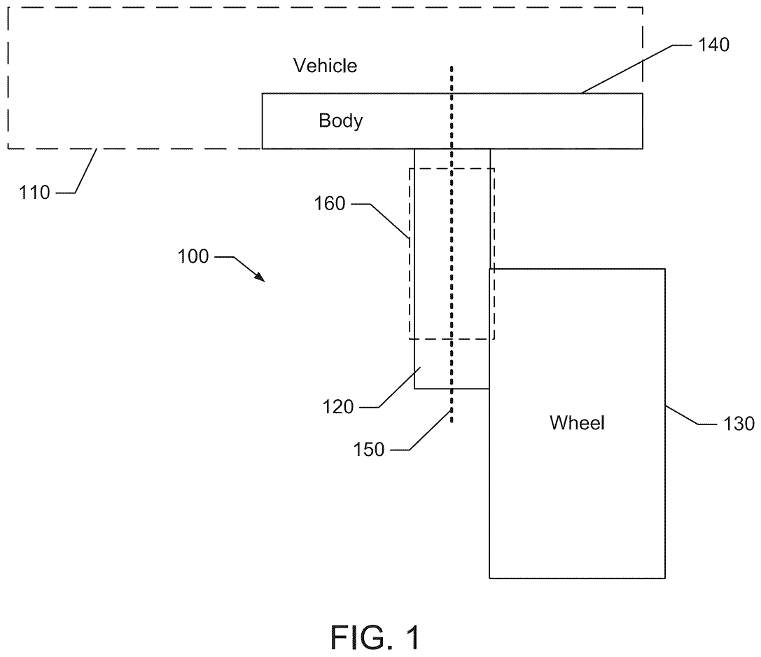

FIG. 1 illustrates a block diagram of the suspension assembly 100 of a vehicle 110 according to an example embodiment. As seen in FIG. 1, in some embodiments the suspension assembly 100 may include a shock absorber 120, which may operably couple to a wheel 130 of the vehicle 110 and to a body 140 (or chassis) of the vehicle 110. In this regard, one of ordinary skill in the art may appreciate that the shock absorber 120 may operably couple to the wheel 130 through a plurality of intermediate components, such as a steering knuckle and a wheel hub, both of which have not been shown in FIG. 1 or described in detail herein for the sake of simplicity. Additionally, in an example embodiment, the vehicle 110 may include unibody construction, casted subframes, or the like, and in such cases the body 140 may also be the frame or chassis of the vehicle 110. In such cases, the shock absorber 120 may be operably coupled to the body 140. However, in some other example embodiments, the vehicle 110 may include a body 140 that may be separate from the frame or chassis and may be operably coupled to the frame or chassis (e.g. body-on-frame construction). In this regard, the shock absorber 120 may be operably coupled to the frame or chassis rather than to the body 140. Regardless, the body 140 may also include the frame or chassis in some cases.

In an example embodiment, the shock absorber 120 may be a shock/spring combination that may permit the wheel 130 to articulate up and down in a direction substantially parallel to a longitudinal axis 150 of the shock absorber 120. In this regard, the shock absorber 120 may dampen the articulation of the wheel 130 so that the movement of the wheel 130 may not translate directly into up and down movement of the body 140. In doing so, the shock absorber 120 may increase the quality of the ride as perceived by passengers within the vehicle 110 by absorbing some of the force from bumps due to the articulation of the wheel 130. Additionally, in an example embodiment, the suspension assembly 100 may include a MacPherson strut construction. In this regard, the shock absorber 120 may also play a role in the steering of the vehicle 110, in which case the shock absorber 120 may be operably coupled to a control arm and the steering knuckle which may act as a steering pivot for the wheel 130. Regardless, in some cases, the shock absorber 120 may be substantially cylindrical in shape and may extend substantially along the longitudinal axis 150. It should be noted that the longitudinal axis 150 of the shock absorber 120 may be oriented at a wide range of angles relative to the wheel 130 and/or the body 140 as well and should not be limited to the vertical orientation depicted by the block diagram of FIG. 1. In other words, the shock absorber 120 may not be aligned substantially vertically, or perpendicular to an axis of rotation of the wheel 130. In some cases, the longitudinal axis 150 of the shock absorber 120 may be oriented substantially parallel to the axis of rotation of the wheel 130, and the shock absorber 120 may thus be oriented substantially horizontally. In other cases the longitudinal axis 150 of the shock absorber 120 may form a variety of angles with the axis of rotation of the wheel 130. Although not depicted herein, in an example embodiment, the suspension assembly 100 may further include a stabilizer bar. The stabilizer bar may be operably coupled to the shock absorber 120 at a first end of the stabilizer bar and also to another shock absorber 120 which may be disposed at the opposite side of the vehicle 110 at a second end of the stabilizer bar. The main function of the stabilizer bar may be to reduce body 140 sway of the vehicle 110, especially through turns.

Also depicted in FIG. 1, in some cases the shock absorber 120 may include an exoskeleton 160. The exoskeleton 160 may be operably coupled to an exterior surface of the shock absorber 120 and may change various performance metrics of the shock absorber 120.

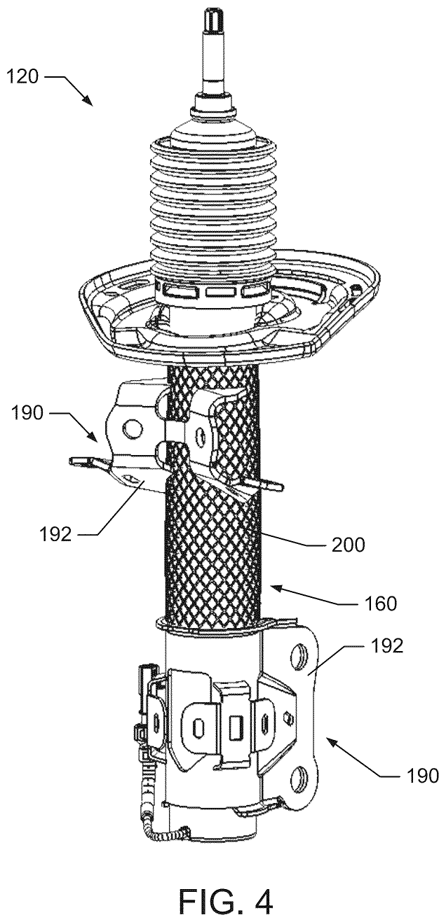

These performance metrics may include, but not be limited to, temperature control, aerodynamics, noise vibration and harshness (NV H) minimization, camber stiffness and the like. Additionally, the exoskeleton 160 may provide additional attachment locations to the exterior of the shock absorber 120, which may enable the shock absorber 120 to be implemented into suspension assemblies 100 having various different subcomponents that may operably couple to the attachment locations of the exoskeleton 160. These subcomponents may include, but not be limited to the stabilizer bar, brake lines, wires (such as wires for sensors or for advanced shock controls), and more. The exoskeleton 160 may take on a variety of forms depending on the specific performance metrics that may be desirable to change, and also based on the particular components and subcomponents that may need to operably couple to the shock absorber 120. FIGS. 4-14 depict various example embodiments in which the exoskeleton 160 may change different performance metrics.

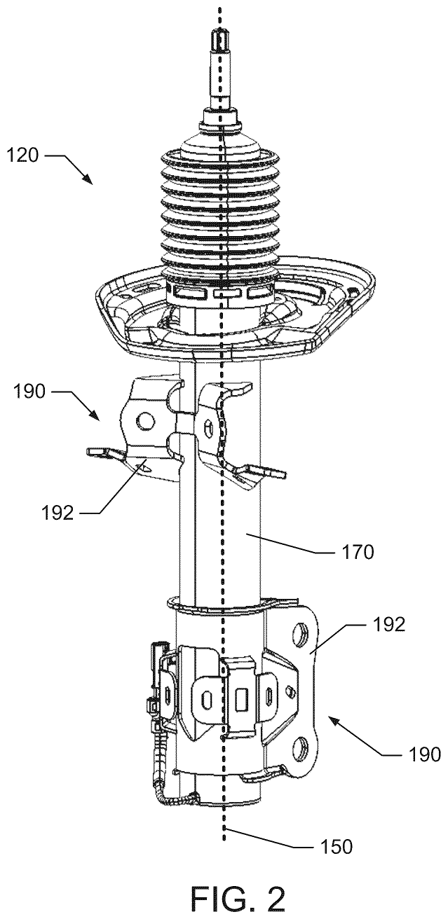

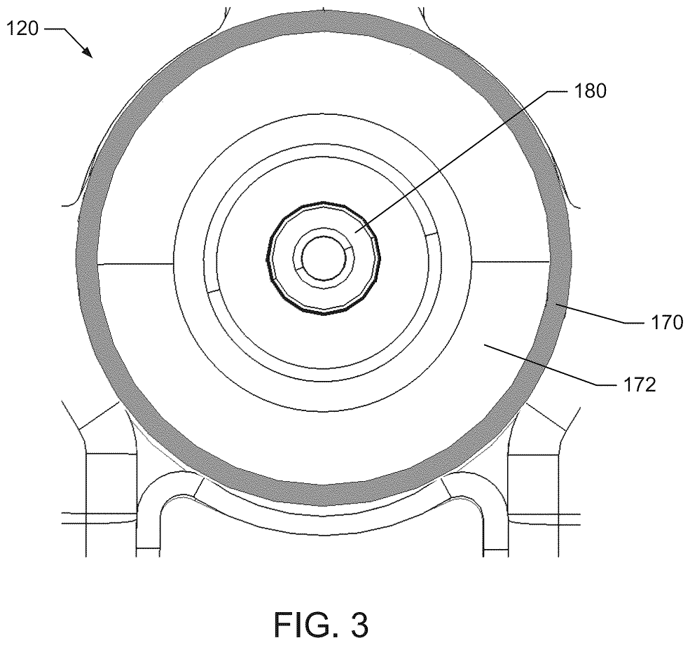

FIG. 2 depicts a perspective view of the shock absorber 120 without the exoskeleton 160 in accordance with an example embodiment, and FIG. 3 depicts a section view of the shock absorber 120 without the exoskeleton 160 in accordance with an example embodiment. As seen in FIGS. 2 and 3, the shock absorber 120 may include a housing 170, a damper 180, and a mounting interface 190. The mounting interface 190 may include brackets 192 that may operably couple the shock absorber to the body 140, the wheel 130, the stabilizer bar, and to other components/subcomponents present on the vehicle 110. The housing 170 may be substantially cylindrical and may extend substantially along the longitudinal axis 150 between the wheel 130 and the body 140 of the vehicle 110. The damper 180 may be operably coupled to the housing 170 and contained within an interior chamber 172 of the housing 170. The damper 180 may be slidable along the longitudinal axis 150 through the interior chamber 172 of the housing 170 and may thus move into and out of the housing 170 responsive to the wheel 130 articulating relative to the body 140. In this regard, the interior chamber 172 of the housing 170 may contain shock fluid, and the shock fluid may help resist the sudden movements of the damper 180 relative to the housing 170. By forcing the damper 180 to move through the shock fluid responsive to the wheel 130 articulating, the jolts and bounces of the wheel 130 articulation may be dampened out by the damper 180. In some cases, the shock absorber 120 may also include a spring to absorb larger shock forces applied to the shock absorber 120.

In the embodiment depicted in FIGS. 2 and 3, the shock absorber 120 may not include the exoskeleton 160. In this regard, the grayed area depicted in FIG. 3 may represent the housing 170 of the shock absorber 120. As shown in FIG. 2, the housing 170 of the shock absorber 120 may have been adapted for its particular use case by adding on additional components that may be needed for the suspension assembly 100 of the particular vehicle 110 on which the shock absorber 120 may be implemented. In this regard, different vehicles, and even different trim levels of the same vehicle, may have different performance or structural characteristics that the shock absorber 120 may need to be adapted to. In fact, even the specific location on the vehicle 110 at which the shock absorber 120 may be implemented may require the shock absorber 120 to have specific compatible structures. For example, the shock absorber 120 shown in FIG. 2 may include the mounting interface 190 operably coupled thereto. The mounting interface 190 in the example embodiment shown in FIG. 2 may include a plurality of brackets 192 which may have been added onto the housing 170 after the production of the housing 170 based on how the shock absorber 120 may be integrated into the vehicle 110. In this regard, the mounting interface 190 may provide attachment locations which may enable the shock absorber 120 to be implemented into suspension assemblies 100 having various different subcomponents that may operably couple to the mounting interface 190. For example, these subcomponents may include, but not be limited to the stabilizer bar, brake lines, wires (such as wires for sensors or for advanced shock controls), and more. In some cases, the mounting interface 190 may be welded onto the housing 170 in the embodiment shown in FIGS. 2 and 3, which may increase the manufacturing difficulty and complexity depending on the geometry of the specific brackets 192 being welded onto the housing 170.

In an example embodiment, the bracket 192 disposed closer to the middle of the housing 170 may operably couple the shock absorber 120 to the stabilizer bar. Accordingly, the bracket 192 may include two flared out portions so that the shock absorber 120 could be implemented in both a right handed and left handed orientation on the vehicle 110. Thus, depending on its use case, the mounting interface 190 may include more brackets 192 in some example embodiments, or fewer brackets 192 in other example embodiments. The brackets 192 disposed closer to the end of the housing 170 may operably couple the shock absorber 120 to the wheel 130. In some cases, this may be accomplished via a knuckle joint. Additional brackets 192 may be included in the mounting interface 190 to integrate hose and wire routing into the exoskeleton 160 and to provide mounting points for the stabilizer bar, brake lines, sensor wires, advanced shock control wires, and others. Accordingly, components such as shock absorbers 120 may need to be adapted to a great extent in order to be implemented on various trims and models of vehicles in a manner that reuses the same base component of the shock absorber 120 due to the varying performance requirements of various trim levels and models of vehicles. This need for adaptation of the shock absorber 120 may greatly increase the manufacturing complexity of the shock absorber 120, reducing the feasibility of offering greater performance for greater value. Therefore, there may be a desire to alter the shock absorber 120 in a less complicated manner via the exoskeleton 160.

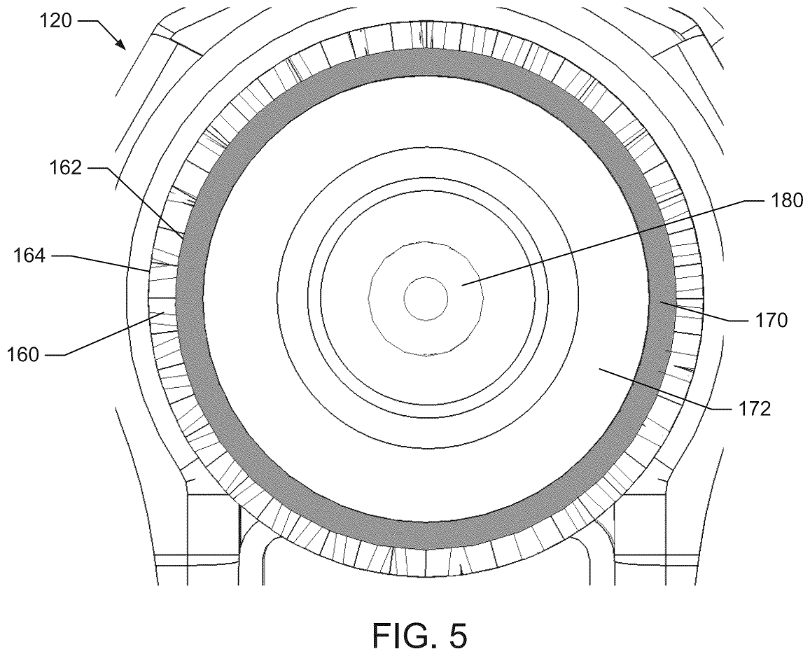

FIG. 4 illustrates the shock absorber 120 having the exoskeleton 160, and FIG. 5 illustrates a top section view of the shock absorber 120 from FIG. 4 having the exoskeleton 160 in accordance with an example embodiment. In this regard, the grayed area depicted in FIG. 5 may represent the housing 170 of the shock absorber 120 and the area surrounding the housing 170 may be the exoskeleton 160. Depending on the desired performance metric to change, the exoskeleton 160 may vary in its appearance. For example, to reduce NV H via the exoskeleton 160, the exoskeleton 160 may be designed to optimize vibration reduction and may include mass dampers to reduce/cancel out resonant frequencies. In the embodiment depicted in FIGS. 4 and 5, the exoskeleton 160 may be designed to change the stiffness of the housing 170 of the shock absorber 120. In this regard, the exoskeleton 160 depicted in FIG. 4 may include a reinforcement pattern 200 that may increase the camber stiffness of the shock absorber 120. Increasing the camber stiffness of the shock absorber 120 may be one way to attain a better balance of performance and value for various trims and models of vehicles.

In some cases, the reinforcement pattern 200 may include a waffle pattern or a mesh pattern that may include a plurality of repeated polygons. The repeated polygons that make up the reinforcement pattern 200 may include rectangles, squares, circles, rhombuses, diamonds, pentagons, hexagons, octagons, or the like. In an example embodiment, the space within the perimeter of each polygon may be empty and each polygon may therefore be hollow. In this regard, the exoskeleton 160 may be formed as a lattice structure that may operably couple to the exterior surface of the housing 170 to increase the stiffness of the housing 170. The reinforcement pattern 200, however it may appear visually, may increase the stiffness of the housing 170 by distributing forces on the housing 170 out over the reinforcement pattern 200, which may in turn also increase the stiffness of the shock absorber 120.

In other cases, the reinforcement pattern 200 may include an asymmetric or non-uniform pattern to optimize specific performance metrics. For instance, in some cases certain portions or locations on the housing 170 may be prone to different loads and the stiffness of the housing 170 may need to be bolstered differently in these different locations. In any case, the exoskeleton 160 may include a reinforcement pattern 200 that may not include the plurality of repeated polygons but instead may include a reinforcement pattern 200 that may be asymmetric. In this regard, the reinforcement pattern may be tailored to change the stiffness of the housing 170 in the particular locations where the additional support may be most needed. In some other cases, the reinforcement pattern 200 may also consider other performance metrics besides the stiffness of the housing 170, such as temperature control. In such cases, the reinforcement pattern 200 may also be non-uniform to optimize the other performance metrics as well. Additionally, the reinforcement pattern 200 may further be designed to consider the efficiency of producing the exoskeleton 160. In this regard, the reinforcement pattern 200 may non-uniform to be simpler or more efficient to manufacture via additive manufacturing techniques. As such, it should be appreciated that the reinforcement pattern 200 may take on a variety of forms based on the performance metrics that may be desirable to optimize in each specific example embodiment of the exoskeleton 160, and should not be limited to either uniform or non-uniform pattern types.

In some cases, the exoskeleton 160 may be formed from a metallic material such as a metal or metal alloy. In fact, in an example embodiment, the exoskeleton 160 may be formed from the same material as the housing 170 itself to reduce manufacturing complexity and to strengthen the operable coupling of the exoskeleton 160 to the housing 170. In some cases, the exoskeleton 160 may be formed from a composite material such as carbon fiber or fiberglass or the like. The composite material may enable the shock absorber 120 to change one or more performance metric and may also minimize the weight added to the housing 170. In an example embodiment, the exoskeleton 160 may be formed from a polymer material such as a plastic. Similarly, the polymer material may also enable the shock absorber 120 to change one or more performance metric and minimize the weight added to the housing 170 as well. In some cases, the exoskeleton may be produced via additive manufacturing techniques, such as 3D printing. This may enable the exoskeleton 160 to be compatible with various shock absorber 120 housing 170 constructions, such as monotube, twin tube, electronically controlled dampers, strut dampers, and the like, since the exoskeleton 160 may be produced to dimensions specific to these housing 170 constructions.

The exoskeleton 160 may include an internal interface 162 and an external interface 164. The internal interface 162 may be disposed on a housing 170 facing side of the exoskeleton 160 and may therefore be operably coupleable to the exterior surface of the housing 170. The external interface 164, on the other hand, may be disposed on an exterior-facing side of the exoskeleton 160. In the example embodiment shown in FIGS. 4 and 5, the exoskeleton 160 may resemble a sleeve that may be operably coupled to the exterior surface of the housing 170 to make the housing 170 stiffer. In this particular embodiment, the external interface 164 may include the reinforcement pattern 200 but may not include the mounting interface 190 formed therein. Instead, the exoskeleton 160 may be formed to operably couple to the housing 170 without interfering with the existing mounting interface 190 of the shock absorber 120, such as the one depicted in FIG. 2.

In the example embodiment shown in FIG. 4 the exoskeleton 160 may change one performance metric of the shock absorber 120 such as the stiffness of the housing 170, but in other example embodiments, the exoskeleton 160 may also change additional performance metrics. For example, the external interface 164 of an example embodiment may include a plurality of fins which may change the temperature control of the shock absorber 120. In another example embodiment, the external interface 164 may include a plurality of air ducts which may change the aerodynamic efficiency of the shock absorber 120 and the temperature control of other components of the vehicle 110 by redirecting cooling air towards them. In some cases, the exoskeleton 160 may include an external bypass for shock fluid which may change the viscosity of the shock fluid. This list of examples should not be considered exhaustive and is provided to illustrate a few possibilities of the exoskeleton 160. In fact, they may be implemented on their own in different embodiments of the exoskeleton 160, or the exoskeleton 160 may include multiple of the above listed examples in a single embodiment to change more than one performance metric simultaneously.

As seen in the cross section shown in FIG. 5, the internal interface 162 may be substantially similar in size and shape to the exterior surface of the housing 170. The internal interface 162 may be formed to substantially match the exterior surface of the housing 170 to fit over the housing 170. The exoskeleton 160 may be operably coupled to the housing 170 by joining the internal interface 162 to the exterior surface of the housing 170. This may be accomplished via crimping, welding, an adhesive, or the like. Regardless, as described above, the external interface 164 may change one or more performance metrics of the shock absorber 120.

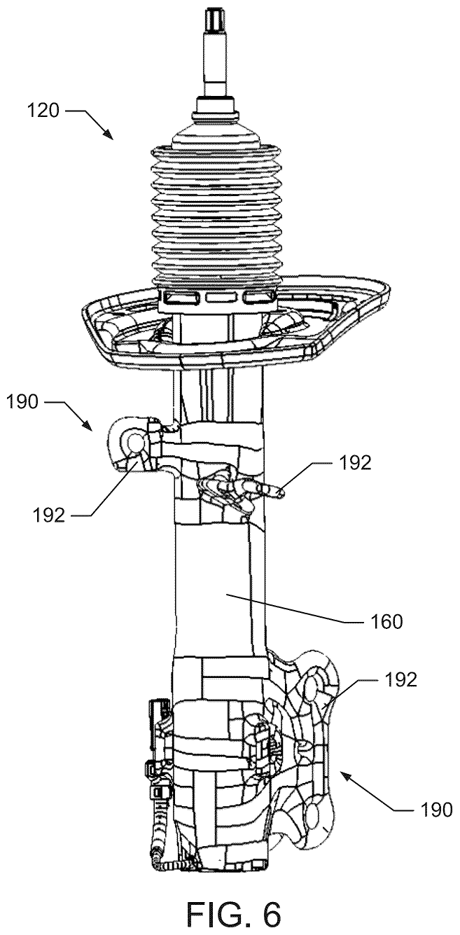

In some cases, the external interface 164 may be operably coupleable to other components of the vehicle 110 via the mounting interface 190 which may be integrally formed at the external interface 164. In this regard, while the exoskeleton 160 depicted in the embodiment shown in FIGS. 4 and 5 may resemble a patterned sleeve operably coupled to a central section of the housing 170 of the shock absorber 120, other embodiments of the exoskeleton 160 may resemble a full shell that may be applied to the housing 170. In this regard, FIGS. 6-14 depict various example embodiments of the exoskeleton 160 that may include a generative fill that may form the shell and have the mounting interface 190 formed integrally at the external interface 164. As such, the manufacturing complexity of customizing the shock absorber 120 may be reduced by eliminating the need to operably couple a unique and separate mounting interface 190 to the housing 170 itself and instead forming the mounting interface 190 integrally with the exoskeleton 160.

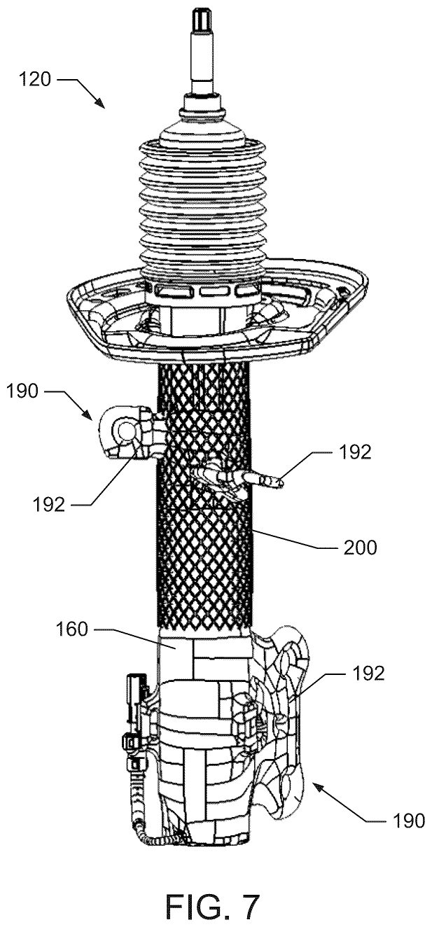

FIG. 6 depicts a perspective view of the shock absorber 120 with the exoskeleton 160 in accordance with an example embodiment. The example embodiment shown in FIG. 6 may illustrate a full shell style exoskeleton 160 structure that may be an alternative to the sleeve style depicted in FIGS. 4 and 5. In this regard, the full shell style structure of the exoskeleton 160 may include the mounting interface 190 formed integrally into the external interface 164. As such, the housing 170 of the shock absorber 120 may not need any of the separate mounting interface 190 components to be operably coupled thereto, and instead they may all be included with the exoskeleton 160. In other words, while the sleeve style exoskeleton 160 shown in FIGS. 4 and 5 may be formed around the mounting interface 190 that may be operably coupled to the housing 170, the full shell style exoskeleton 160 depicted in the embodiment of FIG. 6 may eliminate the need to have the mounting interface 190 operably coupled to the housing 170 and may instead have the mounting interface 190 formed integrally at the external interface 164. In some cases, the sleeve style exoskeleton 160 depicted in FIGS. 4 and 5 may be combined with the full shell style exoskeleton 160 shown in FIG. 6. In this regard, the exoskeleton 160 may not only include an integrated mounting interface 190, but may also change one or more performance metrics of the shock absorber 120. This combination of styles of the exoskeleton 160 will be further described below in reference to FIGS. 7-14.

FIG. 7 depicts a perspective view of the shock absorber 120 with the exoskeleton 160 in accordance with an example embodiment. The exoskeleton 160 shown in FIG. 7 may combine the features of the exoskeleton 160 shown in FIGS. 4 and 5 with the features of the exoskeleton 160 shown in FIG. 6. Accordingly, the exoskeleton 160 may not only include an integrated mounting interface 190, but may also include the reinforcement pattern 200 described above to increase the camber stiffness of the shock absorber 120. Thus, as described above, in some cases, the reinforcement pattern 200 may include a waffle pattern or a mesh pattern that may include a plurality of repeated polygons. The repeated polygons that make up the reinforcement pattern 200 may include rectangles, squares, circles, rhombuses, diamonds, pentagons, hexagons, octagons, or the like. In an example embodiment, the space within the perimeter of each polygon may be empty and each polygon may therefore be hollow. In this regard, the exoskeleton 160 may be formed as a lattice structure that may operably couple to the exterior surface of the housing 170 to increase the stiffness of the housing 170. In other cases, the space within the perimeter of each polygon may be filled in such that the exoskeleton 160 may solidly surround the housing 170. The reinforcement pattern 200, however it may appear visually, may increase the stiffness of the housing 170 by distributing forces on the housing 170 out over the reinforcement pattern 200, which may in turn also increase the stiffness of the shock absorber 120. In other cases, the reinforcement pattern 200 may include an asymmetric or non-uniform pattern to optimize specific performance metrics. As explained above, it should be appreciated that the reinforcement pattern 200 may take on a variety of forms based on the performance metrics that may be desirable to optimize in each specific example embodiment of the exoskeleton 160, and should not be limited to either uniform or non-uniform pattern types.

In some cases, the exoskeleton 160 may be formed separately from the shock absorber 120 and may be operably coupled to the housing 170 after being formed. In other cases, the exoskeleton 160 may be formed directly onto the housing 170 and may be operably coupled to the housing 170 during the formation of the exoskeleton 160. In any case, the housing 170 may be reduced down to the substantially cylindrical tube-like shape, without the mounting interface 190 operably coupled thereto, to enable the exoskeleton 160 to more easily be operably coupled to the housing 170. In this regard, the exoskeleton 160 may include the mounting interface 190 formed integrally therein, thereby further reducing the manufacturing complexity of the shock absorber 120.

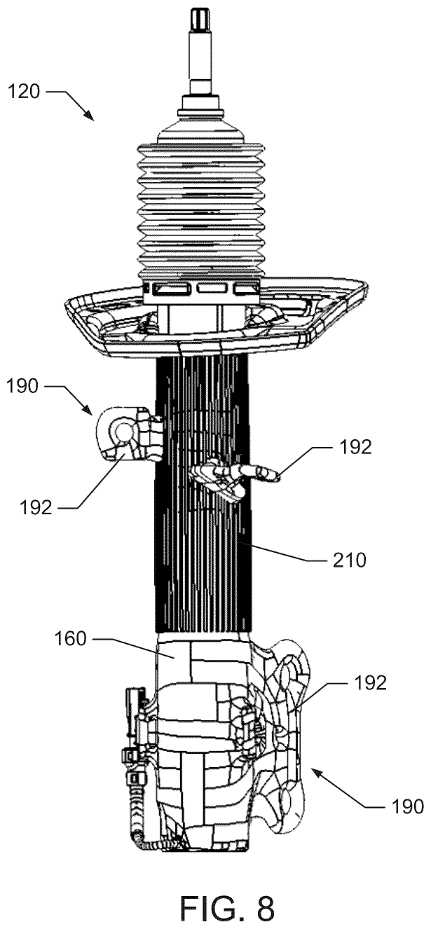

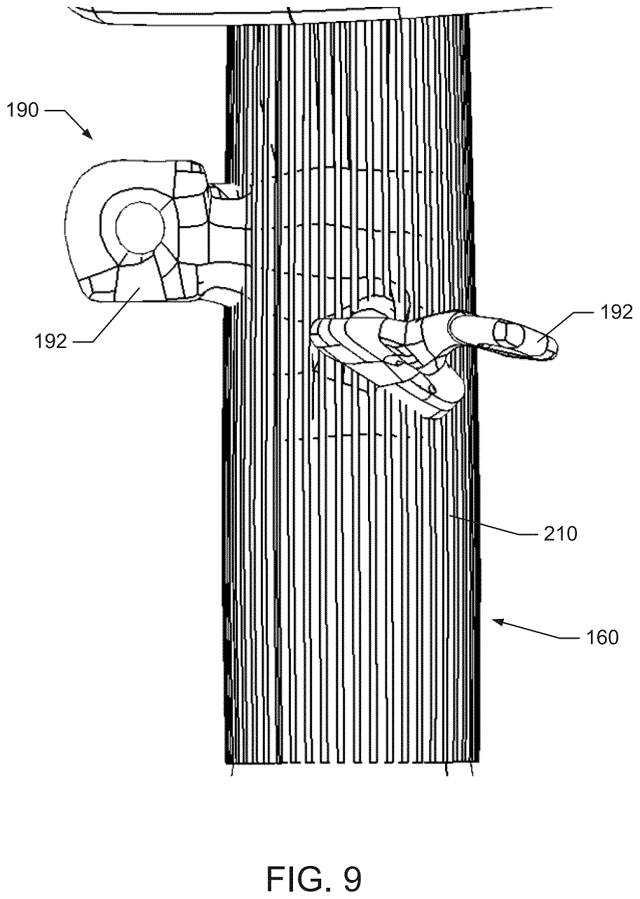

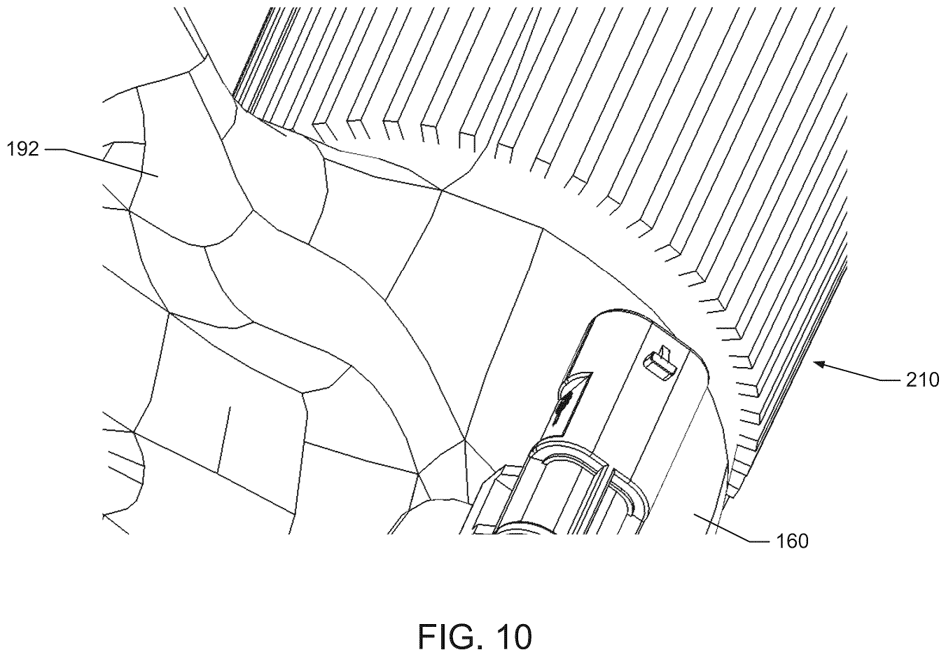

FIG. 8 depicts a perspective view of the shock absorber 120 with the exoskeleton 160, FIG. 9 depicts a close up perspective view of the exoskeleton 160 and FIG. 10 illustrates a close up bottom perspective view of the exoskeleton 160 in accordance with an example embodiment. In the example embodiment depicted in FIGS. 8-10, the external interface 164 of the exoskeleton 160 may include a plurality of fins 210. In such cases, the exoskeleton 160 having the plurality of fins 210 may better control the temperature of the shock absorber 120 by increasing the rate of heat transfer between the shock absorber 120 and the surrounding environment via convection. Temperature control may be an important design consideration for the shock absorber 120 since the temperature of the damper 180 and the shock fluid contained within the housing 170 may directly affect the damping performance of the shock absorber 120, mainly by altering the viscosity of the shock fluid. In this regard, an operating temperature or a range of operating temperatures for the damper 180 may exist and may define peak operation of the damper 180. If the temperature of the damper 180 were to deviate from the operating temperature or to be outside of the range on either end (i.e. higher or lower), the damping performance may be reduced. As such, the goal of the plurality of fins 210 may not be to dissipate as much heat from the housing 170 as possible, but instead to control the temperature of the shock absorber 120 to have the temperature remain either approximately at the operating temperature or substantially within the range of operating temperatures.

As seen in FIG. 10, in some cases, the plurality of fins 210 may be integrally formed at the external interface 164 and may extend outwardly away from the external interface 164. In other words, each fin of the plurality of fins 210 may extend radially out from the housing 170. With cooling fins, the size of each fin and the number of fins may directly affect the effectiveness of the plurality of fins 210 in controlling the temperature of the shock absorber 120. This may be because the size and number of fins may have a direct effect on the effective surface area of the plurality of fins 210 via which heat may be transferred away from the shock absorber 120 via convection. In this regard, as the surface area of the plurality of fins 210 increases, more heat may be transferred away from the shock absorber 120. In the example embodiment depicted in FIGS. 8-10, the plurality of fins 210 may be disposed substantially parallel to the longitudinal axis 150 and spaced apart from each other around the circumference of the external interface 164. In some cases, the plurality of fins 210 could also be oriented substantially perpendicular to the longitudinal axis 150 and spaced apart from each other axially along the external interface 164. In some other cases, the plurality of fins 210 may be oriented in any desirable direction.

Regardless of their orientation, in some cases the plurality of fins 210 may be protrusions of the exoskeleton 160 that may be formed integrally at the external interface 164. In another example embodiment, the plurality of fins 210 may be formed from a shape memory alloy. In this regard, a shape memory alloy (SMA) may be an alloy that may be deformed when cold, but may return to its pre-deformed (i.e. remembered) shape when heated. For example, nitinol is an SM A that may include approximately equal parts Nickel (Ni) and Titanium (Ti). NiTi alloys may change from austenite to martensite upon cooling, and may be a commonly used SMA due to its stability and practicality in such use cases. In this regard, the plurality of fins 210 may be formed from the SM A either by additively manufacturing the SM A into the exoskeleton 160, by bonding the SM A to the exoskeleton 160, or by otherwise operably coupling the SMA to the exoskeleton 160. The plurality of fins 210 may be reduced in size when cool, but may increase in size and exposed surface area when heated and may therefore provide an active cooling effect to maintain the operating temperature of the shock absorber 120. As such, temperature calibration of the SM A may be adjusted to enable the damper 180 of the shock absorber 120 to heat up to the operating temperature or range of operating temperatures. Responsive to the temperature of the damper 180 reaching or exceeding the operating temperature or range of operating temperatures, the plurality of fins 210 may deploy (e.g. change shape) to enhance the cooling effect of the plurality of fins 210. Responsive to the temperature of the damper 180 again reaching or falling below the operating temperature or range of operating temperatures, the plurality of fins 210 may retract (e.g. change shape) to reduce the cooling effect of the plurality of fins 210. In other words, responsive to a temperature of the shock absorber 120 being less than or equal to the operating temperature, the shape memory alloy may change its shape to retract the plurality of fins 210, and responsive to the temperature of the shock absorber 120 exceeding the operating temperature, the shape memory alloy may change its shape to deploy the plurality of fins 210.

In some other cases, SMA's may be electrically actuated as well. In this regard, the SMA may be actuated based on thermal models for the shock absorber 120 or based on metrics that may consider the gross body motion of the damper 180, which may indicate if the shock fluid is overheating or not. In this regard, the exoskeleton 160 may be operably coupled to an on-board computer within the vehicle 110, and responsive to the computer determining that the temperature of the shock absorber 120 may have deviated from the operating temperature or the range of operating temperatures, the SM A may be electrically actuated by passing a current through the SM A to heat up the SM A to its activation temperature to deploy the plurality of fins 210, or by ceasing current flow through the SM A to cool the SM A down below its activation temperature to retract the plurality of fins 210.

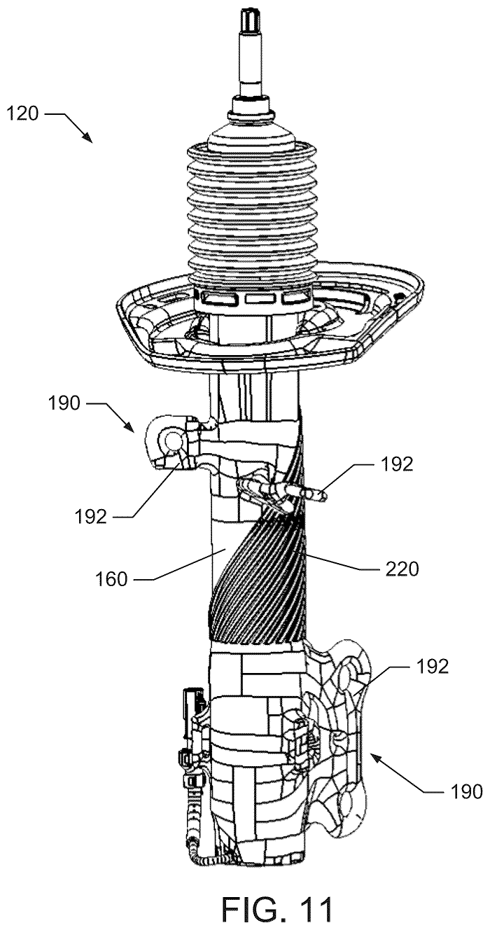

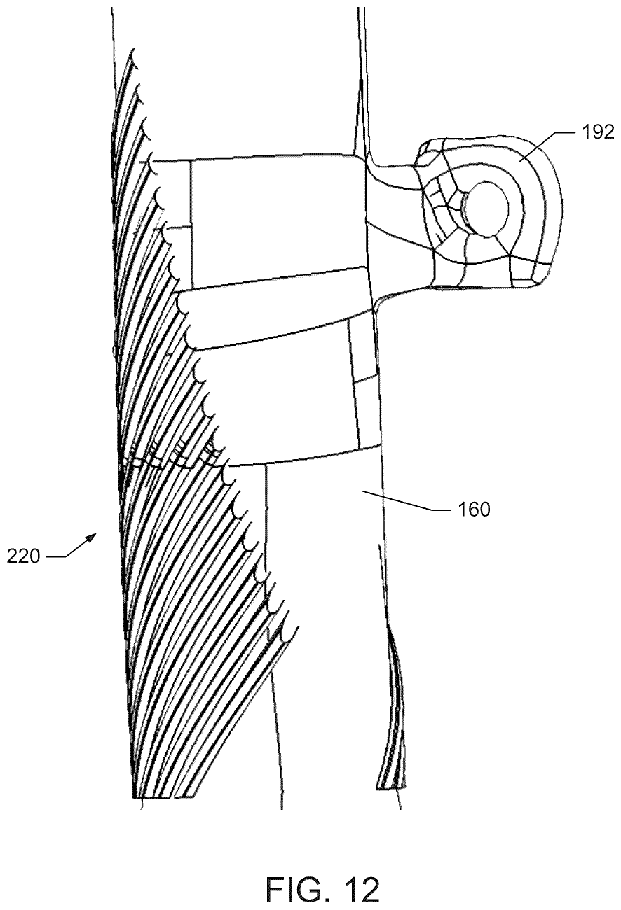

FIG. 11 depicts a perspective view of the exoskeleton 160 and FIG. 12 illustrates a close up perspective view of the exoskeleton 160 in accordance with an example embodiment. In the example embodiment depicted in FIGS. 11 and 12, the performance metric that may be desired to be changed may be the temperature control of other nearby components of the vehicle 110 in addition to the temperature control of the shock absorber 120 itself. In this regard, the external interface 164 may include a plurality of air ducts 220. In some cases, the plurality of air ducts 220 may be integrally formed at the external interface 164 of the exoskeleton 160. Not only may the plurality of air ducts 220 reroute an airflow around the exoskeleton 160 and toward other components of the vehicle 110, but the plurality of air ducts 220 may also help control the temperature of the shock absorber 120 in a similar manner to the plurality of fins 210. In this regard, the plurality of air ducts 220 may also be projections either operably coupled to, or formed integrally at, the external interface 164. However, unlike the plurality of fins 210 which may be formed close together, substantially parallel to the longitudinal axis 150 and distributed uniformly around the circumference of the external interface 164, the plurality of air ducts 220 may be angled and/or curved to guide the airflow towards other components of the vehicle 110 that may also benefit from additional cooling. For example, the plurality of air ducts 220 in some embodiments may direct the airflow toward a brake assembly so that the brake assembly may receive additional cooling. The plurality of air ducts 220 may be channels that may be formed between adjacent projections of the external interface 164. Therefore, in addition to rerouting an airflow toward other components of the vehicle 110 that may benefit from additional cooling, the plurality of air ducts 220 may also simultaneously control the temperature of the damper 180 as well in a manner similar to that of the plurality of fins 210 described above. The plurality of air ducts 220 shown in FIGS. 11 and 12 may curve around the external interface 164 but it should be appreciated that the plurality of air ducts 220 may be oriented in any desirable directions in order to direct the airflow to other components as needed.

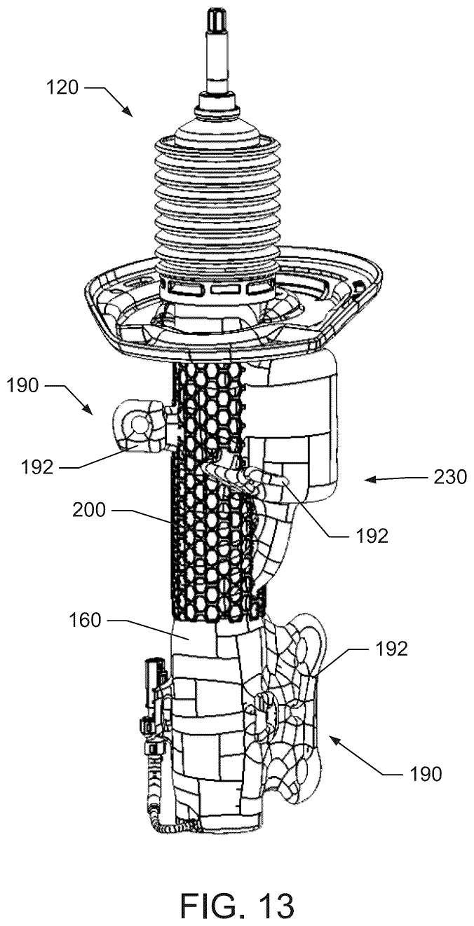

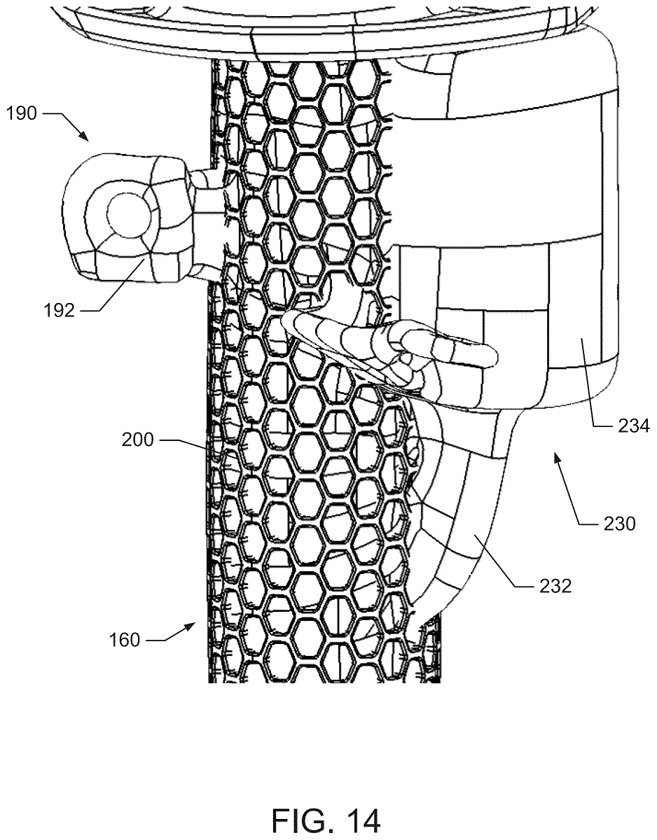

FIG. 13 depicts a perspective view of the exoskeleton 160 and FIG. 14 illustrates a close up perspective view of the exoskeleton 160 in accordance with an example embodiment. In the example embodiment depicted in FIGS. 13 and 14, the performance metric that may be desired to change may be the viscosity of the shock fluid. In this regard, the external interface 164 may include an external bypass 230 at the external interface 164. In some cases, the external bypass 230 may be integrally formed at the external interface 164, but may operably couple to the housing 170 as well. The external bypass 230 may enable shock fluid to flow from the interior chamber 172 of the housing 170, to outside of the housing 170 in the exoskeleton 160 via the external bypass 230 as needed. In this regard, external bypass shock absorbers may often be implemented in high performance off-road vehicles for their ability to offer increased damping performance at higher wheel 130 articulation speeds and loads. In other words, in non-bypass type shock absorbers 120, the damper 180 may not be able to react quick enough in compression and rebound to effectively dampen the articulation motion of the wheel 130 due to the viscosity of the shock fluid resisting the motion of the damper 180 within the housing 170. The external bypass 230 in the exoskeleton 160 may offer increased cooling of the shock fluid by rerouting the shock fluid outside of the housing 170 to increase the damper response.

In some cases, the external bypass 230 may include a fluid channel 232 and a fluid reservoir 234. The fluid channel 232 may be sealed to an opening in the housing 170 to enable the shock fluid to be rerouted into the fluid channel 232. In other words, the fluid channel 232 may be fluidly operably coupled to the interior chamber 172 of the housing 170. The shock fluid may flow through the fluid channel 232 and into the fluid reservoir 234 responsive to compression of the shock absorber 120 and the shock fluid may flow out of the fluid reservoir 234 through the fluid channel 232 and into the interior chamber 172 responsive to rebound of the shock absorber 120. By having the external bypass 230 be integrally formed at the exoskeleton 160 and routed through the exoskeleton 160, the external bypass 230 may be more efficient to produce than machining or welding a separate external bypass to the housing 170.

Importantly, the embodiments disclosed herein may, in some cases, be implemented together as well so that multiple performance metrics may be changed simultaneously. For instance, as shown in FIGS. 13 and 14, the exoskeleton 160 may include the external bypass 230 and the reinforcement pattern 200 so that the stiffness of the shock absorber 120 housing 170 is increased and the shock fluid is also able to bypass the housing 170. The embodiments described herein may be combined or implemented together on the exoskeleton 160 in any combination and also in combination with additional example embodiments of the exoskeleton 160 perhaps not mentioned herein. Accordingly, the exoskeleton 160 may offer modular performance changes to the vehicle 110. For instance, a base trim of a vehicle 110 may include the shock absorber 120 with the exoskeleton 160 that may include the mounting interface 190 integrally formed at the exoskeleton 160 to reduce both the mass of the shock absorber 120 and the complexity of manufacturing the shock absorber 120. Higher trim level vehicles may then include the shock absorber 120 with the exoskeleton 160 that may incorporate additional other features to further change the performance of the vehicle, such as the reinforcement pattern 200, the plurality of fins 210, the plurality of air ducts 220, the external bypass 230 and perhaps others. Therefore, the different and individualized embodiments of the exoskeleton 160 may enable various trim levels, and perhaps various models, of vehicles to share the same shock absorber 120 regardless of the performance characteristics of those vehicles, which may change manufacturing efficiency of the vehicles.

Some example embodiments may provide for a shock absorber for a suspension assembly of a vehicle. The shock absorber may include a housing which may be disposed between a wheel of the vehicle and a body of the vehicle, and an exoskeleton which may be operably coupled to an exterior surface of the housing. The exoskeleton may include an internal interface which may be operably coupleable to the exterior surface of the housing and an external interface which may be operably coupleable to other components of the vehicle via a mounting interface which may be integrally formed at the external interface. The internal interface may be substantially similar in size and shape to the exterior surface of the housing. The external interface may change one or more performance metrics of the shock absorber.

The shock absorber of some embodiments may include additional features, modifications, augmentations and/or the like to achieve further objectives or enhance performance of the shock absorber. The additional features, modifications, augmentations and/or the like may be added in any combination with each other. Below is a non-limiting list of various additional features, modifications, and augmentations that can each be added individually or in any combination with each other. For example, the mounting interface may include a bracket to operably couple hoses and wires to the shock absorber. In some cases, the one or more performance metrics may include temperature control of the shock absorber. In an example embodiment, the external interface may include a plurality of fins. In some cases, the plurality of fins may be integrally formed at the external interface and may extend outwardly away from the external interface. In an example embodiment, the plurality of fins may be formed from a shape memory alloy. In some cases, responsive to a temperature of the shock absorber being less than or equal to an operating temperature, the shape memory alloy may change shape to retract the plurality of fins. In an example embodiment, responsive to the temperature of the shock absorber exceeding the operating temperature, the shape memory alloy may change shape to deploy the plurality of fins. In some cases, the shape memory alloy may be electrically actuated based on thermal models for the shock absorber. In an example embodiment, the one or more performance metrics may include aerodynamic efficiency of the shock absorber and temperature control of the other components of the vehicle. In some cases, the external interface may include a plurality of air ducts integrally formed at the external interface. In an example embodiment, the plurality of air ducts may reroute an airflow around the exoskeleton toward the other components of the vehicle. In some cases, the other components of the vehicle may include a brake assembly. In an example embodiment, the one or more performance metrics may include a stiffness of the housing. In some cases, the external interface may include a reinforcement pattern to increase the stiffness of the housing. In an example embodiment, the one or more performance metrics may include a viscosity of a shock fluid. In some cases, the external interface may include an external bypass integrally formed at the external interface. In an example embodiment, the external bypass may include a fluid channel and a fluid reservoir. In some cases, the fluid channel may be fluidly operably coupled to an interior chamber of the housing. In an example embodiment, the shock fluid may flow through the fluid channel and into the reservoir responsive to compression of the shock absorber and may flow out of the reservoir through the fluid channel into the interior chamber responsive to rebound of the shock absorber.

Some example embodiments may provide for an exoskeleton for a shock absorber for a suspension assembly of a vehicle which may have a housing disposed between a wheel of the vehicle and a body of the vehicle. The exoskeleton may include an internal interface which may be operably coupleable to the exterior surface of the housing and an external interface which may be operably coupleable to other components of the vehicle via a mounting interface which may be integrally formed at the external interface. The internal interface may be substantially similar in size and shape to the exterior surface of the housing. The external interface may change one or more performance metrics of the shock absorber.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

1. A shock absorber for a suspension assembly of a vehicle, the shock absorber comprising:
a housing disposed between a wheel of the vehicle and a body of the vehicle;
an exoskeleton operably coupled to an exterior surface of the housing,
wherein the housing includes an interior chamber containing a damper,
wherein the exoskeleton comprises an internal interface operably coupleable to the exterior surface of the housing and an external interface operably coupleable to other components of the vehicle via a mounting interface integrally formed at the external interface,
wherein the internal interface is substantially similar in size and shape to the exterior surface of the housing, and
wherein the external interface changes one or more performance metrics of the shock absorber.

2. The shock absorber of claim 1, wherein the mounting interface comprises a bracket to operably couple hoses and wires to the shock absorber.

3. The shock absorber of claim 1, wherein the one or more performance metrics comprise temperature control of the shock absorber, and
wherein the external interface comprises a plurality of fins.

4. The shock absorber of claim 3, wherein the plurality of fins is integrally formed at the external interface and extend outwardly away from the external interface.

5. The shock absorber of claim 3, wherein the plurality of fins is formed from a shape memory alloy,
wherein responsive to a temperature of the shock absorber being less than or equal to an operating temperature, the shape memory alloy changes shape to retract the plurality of fins, and
wherein responsive to the temperature of the shock absorber exceeding the operating temperature, the shape memory alloy changes shape to deploy the plurality of fins.

6. The shock absorber of claim 5, wherein the shape memory alloy is electrically actuated based on thermal models for the shock absorber.

7. The shock absorber of claim 1, wherein the one or more performance metrics comprise aerodynamic efficiency of the shock absorber and temperature control of the other components of the vehicle, and
wherein the external interface comprises a plurality of air ducts integrally formed at the external interface.

8. The shock absorber of claim 7, wherein the plurality of air ducts reroute an airflow around the exoskeleton toward the other components of the vehicle, and
wherein the other components of the vehicle comprise a brake assembly.

9. The shock absorber of claim 1, wherein the one or more performance metrics comprise a stiffness of the housing, and
wherein the external interface comprises a reinforcement pattern to increase the stiffness of the housing.

10. The shock absorber of claim 1, wherein the one or more performance metrics comprises a viscosity of a shock fluid, and
wherein the external interface comprises an external bypass integrally formed at the external interface.

11. The shock absorber of claim 10, wherein the external bypass comprises a fluid channel and a fluid reservoir,
wherein the fluid channel is fluidly operably coupled to an interior chamber of the housing, and
wherein the shock fluid flows through the fluid channel and into the reservoir responsive to compression of the shock absorber and out of the reservoir through the fluid channel into the interior chamber responsive to rebound of the shock absorber.

12. An exoskeleton for a shock absorber for a suspension assembly of a vehicle having a housing disposed between a wheel of the vehicle and a body of the vehicle, wherein the exoskeleton comprises an internal interface operably coupleable to an exterior surface of the housing and an external interface operably coupleable to other components of the vehicle via mounting interface integrally formed at the external interface,
wherein the housing includes an interior chamber containing a damper,
wherein the internal interface is substantially similar in size and shape to the exterior surface of the housing, and
wherein the external interface increases one or more performance metrics of the shock absorber.

13. The exoskeleton of claim 12, wherein the one or more performance metrics comprise temperature control of the shock absorber,
wherein the external interface comprises a plurality of fins, and
wherein the plurality of fins is integrally formed at the external interface and extend outwardly away from the external interface.

14. The exoskeleton of claim 13, wherein the plurality of fins is formed from a shape memory alloy,
wherein responsive to a temperature of the shock absorber being less than or equal to an operating temperature, the shape memory alloy changes shape to retract the plurality of fins, and
wherein responsive to the temperature of the shock absorber exceeding the operating temperature, the shape memory alloy changes shape to deploy the plurality of fins.

15. The exoskeleton of claim 14, wherein the shape memory alloy is electrically actuated based on thermal models for the shock absorber.

16. The exoskeleton of claim 12, wherein the one or more performance metrics comprise aerodynamic efficiency of the shock absorber and temperature control of the other components of the vehicle, and
wherein the external interface comprises a plurality of air ducts integrally formed at the external interface.

17. An exoskeleton for a shock absorber for a suspension assembly of a vehicle having a housing disposed between a wheel of the vehicle and a body of the vehicle, wherein the exoskeleton comprises an internal interface operably coupleable to an exterior surface of the housing and an external interface operably coupleable to other components of the vehicle via mounting interface integrally formed at the external interface,
wherein the housing includes an interior chamber containing a damper,
wherein the internal interface is substantially similar in size and shape to the exterior surface of the housing,
wherein the external interface increases one or more performance metrics of the shock absorber,
wherein the plurality of air ducts reroute an airflow around and towards a base of the exoskeleton and the other components of the vehicle, and
wherein the other components of the vehicle comprise a brake assembly.

18. The exoskeleton of claim 12, wherein the one or more performance metrics comprise a stiffness of the housing, and
wherein the external interface comprises a reinforcement pattern to increase the stiffness of the housing.

19. The exoskeleton of claim 12, wherein the one or more performance metrics comprises a viscosity of a shock fluid, and
wherein the external interface comprises an external bypass integrally formed at the external interface.

20. The exoskeleton of claim 19, wherein the external bypass comprises a fluid channel and a fluid reservoir,
wherein the fluid channel is fluidly operably coupled to an interior chamber of the housing, and
wherein the shock fluid flows through the fluid channel and into the reservoir responsive to compression of the shock absorber and out of the reservoir through the fluid channel into the interior chamber responsive to rebound of the shock absorber.
